(19) United States
(12) Patent Application Publication
(10) Pub. No.: US 2008/0240510 A1
(43) Pub. Date: Oct. 2, 2008

(54) METHOD AND SYSTEM FOR EXAMINING A SURFACE

(76) Inventors: Greg Dale, Novi, MI (US); Michael J. Mater, Chelsea, MI (US)

Correspondence Address: SCHOX PLC, 730 Florida Street #2, San Francisco, CA, 94110, US

(21) Appl. No.: 11/865,665

(22) Filed: Oct. 1, 2007

Related U.S. Application Data
(60) Provisional application No. 60/827,707, filed on Sep. 30, 2006.

(51) Int. Cl. G06K 9/00

(52) U.S. Cl. 382/108

(57) ABSTRACT

The present invention includes a system and a method of determining the regularity of a surface of an object under examination. The method includes receiving a three-dimensional phase image of the surface including a plurality of pixels, wherein the phase image can result from a multiple wavelength interferometric analysis of the surface. The method can further include the steps of determining a relative height of the pixels in response to the phase image of the surface, creating a statistical map of the surface in response to the relative height of the pixels, and determining the regularity of the surface of the object under examination in response to the statistical map of the surface. The system includes an interferometric apparatus connected to a controller, wherein the controller is adapted to perform one or more functions similar to the method of the present invention.

### CROSS-REFERENCE TO RELATED APPLICATIONS

This application claims the benefit of U.S. Provisional Application No. 60/827,707 filed 30 Sep. 2006 and entitled “Method and Apparatus for Measuring Parts”, which is incorporated in its entirety by this reference.

### TECHNICAL FIELD

The present invention relates generally to the field of interferometry, and more particularly to the field of interferometric methods and systems for determining the regularity of a surface related to a manufacturing process.

### BACKGROUND

A large number of manufacturers in the automotive, aerospace, semiconductor, and medical device industries spend countless resources and time not only in the design and manufacture of specialized parts, but also in the inspection and quality control procedures that ensure the proper operation of the finished product. Many of the current inspection and quality control protocols involve numerous man-hours, and the tasks are becoming even more complicated given the decreasing size of many consumer goods and their constituent parts.

While some automated inspection systems have been developed to aid companies in the manufacturing process, many of these systems lack a number of desirable features. For instance, inspection systems relying on optical data in the visible range of the electromagnetic spectrum can easily fail to detect small variations in the surface of an object. Similarly, to the extent that automated systems may use interferometric techniques, they typically do not employ a sufficient number of wavelengths to resolve the various ambiguities that arise in the detection of very small imperfections on very small surfaces.

Thus, there is a need in the interferometry field to create an improved method and system for examining a surface. This invention provides such improved method and system.

### BRIEF DESCRIPTION OF THE FIGURES

FIG. 1 is a flowchart of a method for examining the surface of an object under examination in accordance with a method of the preferred embodiment.

FIG. 2 is a flowchart of a method for examining the surface of an object under examination in accordance with one or more variations of the method of the preferred embodiment.

FIG. 3 is a schematic block diagram of a system for examining the surface of an object under examination in accordance with a system of the preferred embodiment.

### DESCRIPTION OF THE PREFERRED EMBODIMENTS

The preferred embodiments of the invention include a method of determining the regularity of a surface of an object under examination, and a system for examining a surface. The following description of the preferred embodiments of the invention is not intended to limit the invention to these preferred embodiments, but rather to enable any person skilled in the art of interferometry to make and use this invention.

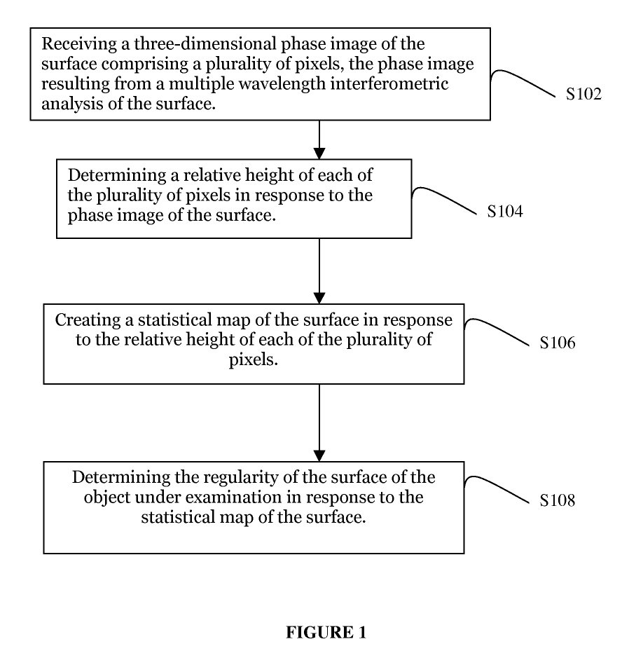

As shown in FIG. 1, the method of the preferred embodiment includes: receiving a three-dimensional phase image of the surface based on a multiple wavelength interferometric analysis of the surface, wherein the phase image of the surface includes a plurality of pixels S102; determining a relative height of the pixels in response to the phase image of the surface S104; creating a statistical map of the surface in response to the relative height of the pixels S106; and determining the regularity of the surface of the object under examination in response to the statistical map of the surface S108.

Step S102 of the method of the preferred embodiment recites receiving a three-dimensional phase image of the surface includes a plurality of pixels, the phase image resulting from a multiple wavelength interferometric analysis of the surface. The phase image can be generated by an interferometric apparatus, such as the one described below, which can be connected to one or more controllers, microcomputers, processors adapted for data and image processing. The phase image functions in part to determine a range or depth profile of a three-dimensional image of an object, such as for example a precision machined part, semiconductor wafer, or any other object under examination.

Step S104 of the method of the preferred embodiment recites determining a relative height of each of the pixels in response to the phase image of the surface. Step S104 functions to extract the necessary phase data for each of the wavelengths used in the interferogram and to reduce the amount of gross data associated with any single pixel in the phase image. For example, if the method utilizes six phases of sixteen wavelengths and between ten and twelve bit numbers per pixel, then there would be approximately one thousand bits of information per pixel. Step S104 reduces the gross amount of data associated with any one pixel by converting the raw phase and/or wavelength data into a relative height parameter. The unused gross data can be eliminated or sequestered for later use according to one or more variations of the method of the preferred embodiment.

Step S106 of the method of the preferred embodiment recites creating a statistical map of the surface in response to the relative height of each of the pixels. Step S106 functions to analyze the relative height data and calculate and/or show the statistical relationship between each of the pixels by segmenting, grouping, normalizing and/or otherwise organizing the plurality of pixels according to the statistical properties of their relative heights. The statistical properties can be determined according to any suitable mathematical or statistical operation, including Gaussian analysis, Markovian analysis, and/or regressive or recursive analysis. In one variation of the preferred embodiment, the method can employ a fast Fourier transform (FFT) in one or both of steps S102 and S104, the results of which can be statistically analyzed in step S106 to recognize physical patterns in the surface of the object. For example, if the secondary peaks of the FFT function are displaced a different distance relative to the main peak, or if the side lobes of the FFT function are statistically different, then the method of the preferred embodiment can conclude that there is a consistent pattern on the surface of the object, such as a recurring tool mark on a series of precision machined parts.

Step S108 of the method of the preferred embodiment recites determining the regularity of the surface of the object under examination in response to the statistical map of the surface. Step S108 allows a manufacturer of the object, such as a precision machinist or semiconductor fabricator, to assess the viability and/or functionality of its product. The regularity of the surface can be determined through normalization of the surface qualities, through comparative processes, or through statistical operations adapted to compare the statistical map to certain predetermined threshold parameters for the surface contours.

In a variation of the method of the preferred embodiment, the multiple wavelength interferometric analysis of the surface includes more than two wavelengths of light. In interferometry, a two-wavelength analysis has an inherent ambiguity level that is inversely proportional to the wavelength separation. Unfortunately, as one decreases the wavelength separation for large range ambiguity, the range (depth) resolution of the interferometer is also reduced. This inverted relationship between ambiguity and resolution can be undesirable in certain applications, such as when the surface of the object under examination is a precision machined, in which case both high ambiguity and high resolution are required. Accordingly, this variation of the method of the preferred embodiment employs more than two wavelengths of light to preserve the range resolution and reduce ambiguity in the interferometric analysis. As noted above, the method of the preferred embodiment can employ at least up to sixteen wavelengths of light of six phases in order to generate a suitable amount of data for each pixel in the phase image.

In another variation of the method of the preferred embodiment, step S102 can further include, for each of the pixels and for each wavelength of light, extracting a peak value of a Fourier transform resulting in a phase value for each of the pixels. Because the method of the preferred embodiment can employ more than two wavelengths of light, and at least up to sixteen wavelengths of light per pixel, this variation of step S102 can include at least up to sixteen Fourier transforms per pixel generating at least up to sixteen phase values per pixel. The peak value can be determined using curve-fitting techniques and/or by oversampling the Fourier transform in the range domain and selecting the peak value of the range image.

In another variation of the method of the preferred embodiment, step S108 can further include the step of comparing the statistical map of the surface of the object under examination to a statistical map of a comparable surface of a comparable object. This variation of step S108 can include for example retaining, in a memory storage device, a history of any previous analysis of a comparable surface, such as for example a similar object to that under examination. In one alternative, the statistical map of the comparable surface is generated by performing at least steps S102, S104 and S106 on the comparable surface prior to performing at least step S108 on the surface of the object under examination. For example, if one or more objects are arranged on a conveyor, the method according to this variation of the preferred embodiment can generate and retain a statistically averaged map of any prior-examined surfaces, thereby maintaining a running and constantly updated normalized surface profile for two or more in a series of objects. In another alternative, the statistical map of the comparable surface can include an idealized statistical map of the comparable surface. For example, a user and/or operator can input or upload a statistical map of how an ideal surface would appear to an interferometer, such as a perfectly smooth and perfectly contoured precision machined part. Any such idealized statistical map can be generated using a computer aided drafting software program, or a CNC machining program thereby allowing direct comparison between the object under examination and an ideal image of how the object should appear to the interferometer.

In another variation of the method of the preferred embodiment, step S108 can further include the step of identifying one or more marks on the surface of the object under examination in response to the statistical map of the surface of the object. In this variation of the method of the preferred embodiment, the method can be employed to recognize tool or machining marks on a precision machined part or object, which in turn allows a user and/or operator to track the performance of its machining apparatus. For example, by identifying and/or tracking one or more of a series of tool marks, this variation on the method of the preferred embodiment allows a user and/or operator to assess whether the machining equipment is properly functioning, whether it is causing undue wear on the manufactured parts, whether it needs repair, and/or whether it needs computational or manual adjustments.

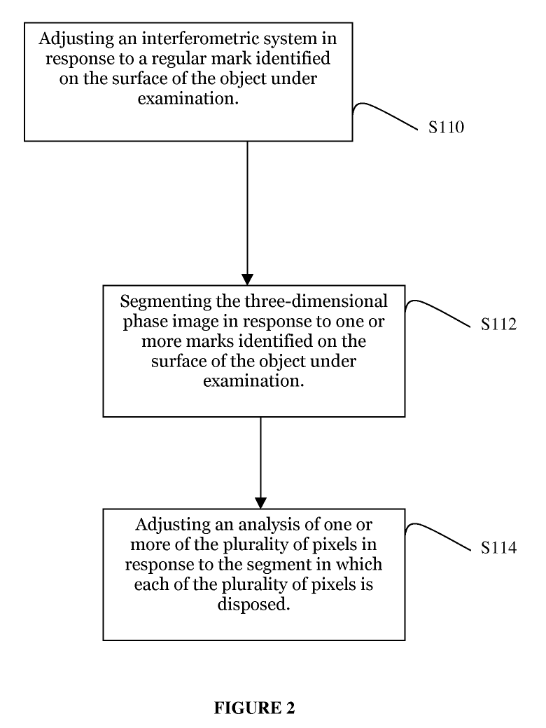

As shown in FIG. 2, the method of an alternative embodiment of the invention includes, in response to the step of identifying one or more marks on the surface of the object under examination and based on the statistical map of the surface of the object, adjusting an interferometric system in response to a regular mark identified on the surface of the object under examination Silo. In this alternative, if a mark is determined to be a regular mark, relative to its statistical properties for example, then this variation of the method can cause one or both of an interferometer or a controller to adjust its measurement and/or computational behavior in accordance therewith. For example, if a tool mark is identified as a regular tool mark, then the controller can be adjusted such that it automatically recognizes the mark as such, thereby saving a considerable amount of time and computational power in not having to recalculate a detailed statistical map of the surface of the object in that designated area.

Another alternative includes step S112, which recites segmenting the three-dimensional phase image in response to one or more marks identified on the surface of the object under examination. The one or more marks can be regular, i.e. generated by repeated machining or tooling, or irregular or aberrant. In response to the segmentation, the method can perform step S114, which recites adjusting an analysis of one or more of the pixels in response to the segment in which each of the pixels is disposed. For example, the method can perform one or more of the following adjustments to the analysis: adjusting the density of a set of reference pixels usable in determining the relative height of the pixels, adjusting the exposure time of the interferometric system for one or more segments, or adjusting a focal parameter of the interferometric system for one or more segments. Each of these adjustments can be performed by or at one or both of an interferometer or a controller.

In another variation, the method of the preferred embodiment may include the step of identifying a defect on the surface of the object under examination in response to the three-dimensional phase image of the surface. As noted above, the range or depth of a pixel can be determined as a function of the wavelength and phase of the incident light from a multifrequency interferometer. Any aberrant range or height measurement within a pixel can be indicative of a surface defect. Additionally, the method of the preferred embodiment can employ other parameters, such as phase correlation, depth of modulation, and reflectivity as a function of wavelength in order to determine more information about a sub-pixel surface feature. In one alternative to this variation, the step of identifying a defect on the surface of the object under examination can include the step of identifying a defective pixel within the pixels. Defective pixels can be identified by any number of statistical or analytical methods. For example, a defective pixel can be identified by a relationship between magnitude-based and normalized synchronization functions, a sub-threshold value within a region of a magnitude-based or normalized synchronization peak function, a global low value in a magnitude-based or normalized synchronization peak function, or based on a spatial relationship between one bad pixel and its surrounding pixels. For example, if one pixel is surrounded by more than five bad pixels, then that pixel can also be identified as defective. Alternatively, if more of a pixels immediate neighbors (for example in a three by three matrix) are defective than not, then the center pixel can also be identified as bad or defective. In another alternative to the variation of the method of the preferred embodiment, the method can further include the step of clustering the defective pixels in order to determine (or at least approximate) a parameter of the defect on the surface, such as size, shape, volume, and/or location. In some industries, parts or objects must meet certain defect thresholds prior to introduction into the stream of commerce. As such, this alternative embodiment of the method functions to aggregate any defects in the surface of the object into what might be considered to be larger defects, i.e. larger divots, scrapes, pores or tool markings that render the object unfit for sale. On the other hand, if defective pixels are sufficiently spaced apart, then that might tend to indicate that the object, while not having an ideal surface, nevertheless is suitable for its intended purpose.

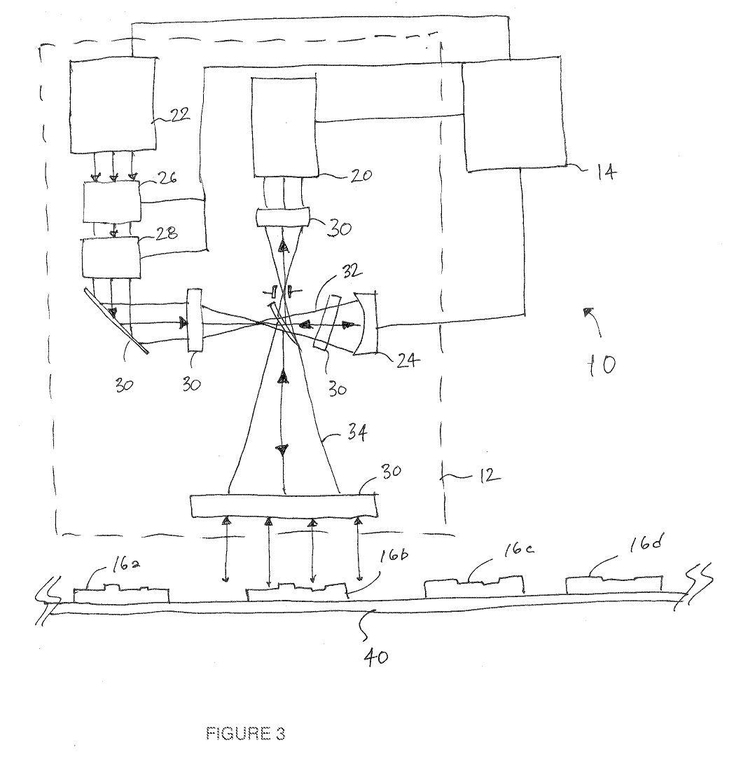

As shown in FIG. 3, the system 10 of the preferred embodiment includes an interferometric apparatus 12 adapted to generate a three-dimensional phase image of a surface of an object under examination and a controller 14 connected to the interferometric apparatus 12. In the system 10 of the preferred embodiment, the controller 14 is adapted to determine a relative height of each of the pixels in response to the phase image of the surface; create a statistical map of the surface in response to the relative height of each of the pixels; and determine the regularity of the surface of the object under examination in response to the statistical map of the surface. In operation, one or more objects 16a, 16b, 16c, 16d can be positioned on a platform 40, for example a conveyor, whereupon the system 10 of the preferred embodiment inspects at least one surface of one or more of the objects 16a, 16b, 16c, 16d.

The interferometric apparatus 12 of the system 10 of the preferred embodiment functions to generate a three-dimensional phase image of an object 16b under examination. In one variation of the preferred embodiment, the interferometric apparatus includes a tunable laser 22. Light from the tunable laser 22 can split into object and reference beams, 34 and 32, respectively, using a plurality of optical components 30 arranged according to the particular imaging requirements of the system 10. The object beam 34 reflects from an object 16b and travels back into a detector array 20. The reference beam 32 is reflected by a reference mirror 24 and travels back into the detector array 20 as well. Light from the two beams interferes, and the interference pattern is recorded by the detector array 20. The interferometric apparatus 12 can further include one or more beam conditioners 26, 28 that are adapted to alter the phase, direction, spot size or intensity of any laser light from the tunable laser 22. Phase shifting can be used to record the complex-valued interference image, which can be accomplished by moving the reference mirror 24 with an actuator (not shown). The phase of the interference image contains information about the profile (also referred to as range or depth) of the object 16b being inspected.

The interferometric apparatus 12 of the system 10 can be used to perform single wavelength interferometry, two wavelength interferometry, or multi-wavelength (i.e., more than two wavelengths) interferometry from which three-dimensional phase images can be developed and analyzed by the controller 14. As noted above, two-wavelength interferometry has an inherent ambiguity level that is inversely proportional to the wavelength separation. As one decreases the wavelength separation for large range ambiguity, the range (depth) resolution of the interferometer is also reduced. This inverted relationship between ambiguity and resolution can be undesirable in certain applications, such as when the surface of the object under examination is a precision machined part or a semiconductor wafer, in which case both low ambiguity and high resolution are required. Accordingly, this variation of the system 10 of the preferred embodiment employs more than two wavelengths of light to preserve the range resolution and reduce ambiguity in the interferometric analysis. As noted above, the system 10 of the preferred embodiment can employ at least up to sixteen wavelengths of light of six phases in order to generate a suitable amount of data for each pixel in the phase image.

In another variation of the system 10 of the preferred embodiment, the controller 14 can be adapted to extract, for each of the pixels and for each wavelength of light, a peak value of a Fourier transform resulting in a phase value for each of the pixels. Because the system 10 of the preferred embodiment can employ more than two wavelengths of light, and at least up to sixteen wavelengths of light per pixel, this variation of the system 10 can include at least up to sixteen Fourier transforms per pixel generating at least up to sixteen phase values per pixel. As noted above, the peak value can be determined using curve-fitting techniques and/or by oversampling the Fourier transform in the range domain and selecting the peak value of the range image.

In another variation of the system 10 of the preferred embodiment, the controller 14 can be further adapted to compare the statistical map of the surface of the object under examination to a statistical map of a comparable surface of a comparable object. This adaptation of the controller 14 can include for example retaining, in a memory storage device, a history of any previous analysis of a comparable surface, such as for example a similar object to that under examination. In one alternative, the statistical map of the comparable surface is generated by performing a prior analysis on objects 16c, 16d on the comparable surface prior to performing the same analysis on the surface of the object 16b under examination. For example, if one or more objects 16a, 16b, 16c, 16d are arranged on a conveyor 40, the controller 14 according to this variation of the preferred embodiment can generate and retain a statistically averaged map of any prior-examined surfaces, thereby maintaining a running and constantly updated normalized surface profile for two or more in a series of objects 16a, 16b, 16c, 16d. In another alternative, the statistical map of the comparable surface can include an idealized statistical map of the comparable surface. For example, a user and/or operator can input or upload a statistical map of how an ideal surface would appear to an interferometer to the controller 14. An ideal surface may be representative of a perfectly smooth and perfectly contoured precision machined part. Any such idealized statistical map can be generated using a computer aided drafting software program, or a CNC machining program thereby allowing direct comparison between the object 16b under examination and an ideal image of how the object should appear to the interferometric apparatus 12.

In another variation of the system 10 of the preferred embodiment, the controller 14 can be further adapted to identify one or more marks on the surface of the object 16b under examination in response to the statistical map of the surface of the object 16b. In this variation of the system 10 of the preferred embodiment, the controller 14 can be adapted to recognize tool or machining marks on a precision machined part or object, which in turn allows a user and/or operator to track the performance of its machining apparatus. For example, by identifying and/or tracking one or more of a series of tool marks, controller 14 can be adapted to notify a user and/or operator to assess whether the machining equipment is properly functioning, whether it is causing undue wear on the manufactured parts, whether it needs repair, and/or whether it needs computational or manual adjustments. Suitable notification from the controller 14 can be communicated through visual and/or audio signals, or a combination thereof, using for example a display and/or speaker system (not shown).

Alternatively, in response to the step of identifying one or more marks on the surface of the object under examination in response to the statistical map of the surface of the object, the controller 14 can be adapted to adjust the measurement and/or analytic capabilities of the system 10. For example, if a tool mark is identified as a regular tool mark, then the controller 14 can be adjusted such that it automatically recognizes the mark as such, thereby saving a considerable amount of time and computational power in not having to recalculate a detailed statistical map of the surface of the object in that designated area.

In another alternative to the variation of the system 10 of the preferred embodiment, the controller 14 can be adapted to segment the three-dimensional phase image in response to one or more marks identified on the surface of the object under examination. The one or more marks can be regular, i.e. generated by repeated machining or tooling, or irregular or aberrant. In response to the segmentation, the controller 14 can be further adapted to adjust the operation of the system 10 at least with reference to the segment in which each of the pixels is disposed. For example, the controller 14 can adjust at least the following parameters: the density of a set of reference pixels usable in determining the relative height of the pixels, the exposure time of the interferometric apparatus 12 for one or more segments, or a focal parameter of the interferometric apparatus 12 for one or more segments.

In another variation of the system 10 of the preferred embodiment, the controller 14 can be adapted to identify a defect on the surface of the object 16b under examination in response to the three-dimensional phase image of the surface. As noted above, the range or depth of a pixel can be determined as a function of the wavelength and phase of the incident light from a multifrequency interferometer. Any aberrant range or height measurement within a pixel can be indicative of a surface defect. Additionally, the controller 12 of the system 10 of the preferred embodiment can employ other parameters, such as phase correlation, depth of modulation, and reflectivity as a function of wavelength in order to determine more information about a sub-pixel surface feature.

In one alternative to this variation of the system 10 of the preferred embodiment, the controller 12 can be adapted to identify a defect on the surface of the object under examination by identifying a defective pixel within the pixels. As noted above, defective pixels can be identified by any number of statistical or analytical methods. For example, a defective pixel can be identified by a relationship between magnitude-based and normalized synchronization functions, a sub-threshold value within a region of a magnitude-based or normalized synchronization peak function, a global low value in a magnitude-based or normalized synchronization peak function, or based on a spatial relationship between one bad pixel and its surrounding pixels. For example, if one pixel is surrounded by more than five bad pixels, then that pixel can also be identified as defective. Alternatively, if more of a pixels immediate neighbors (for example in a three by three matrix) are defective than not, then the center pixel can also be identified as bad or defective.

In another alternative to the variation of the system 10 of the preferred embodiment, the controller 14 can be further adapted to cluster the defective pixels in order to determine (or at least approximate) a size of the defect on the surface. In some industries, parts or objects must meet certain defect thresholds prior to introduction into the stream of commerce. As such, in this alternative embodiment of the system 10, the controller 12 functions to aggregate any defects in the surface of the object into what might be considered to be larger defects, i.e. larger divots, scrapes, pores or tool markings that render the object unfit for sale. On the other hand, if defective pixels are sufficiently spaced apart, then that might tend to indicate that the object, in spite of any minor defects, is nevertheless suitable for its intended purpose.

The controller 14 of the system 10 of the preferred embodiment can be integrated with the interferometric apparatus 12 or connected from a remote location. The controller 14 can be adapted to perform various functions and/or steps, which can be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination designed to perform the functions and/or steps described herein. A general-purpose processor may be a microprocessor, but in the alternative, the processor may be any conventional processor, microcontroller, or state machine.

As a person skilled in the art of interferometry will recognize from the previous detailed description and from the figures and claims, modifications and changes can be made to the preferred embodiment of the invention without departing from the scope of this invention defined in the following claims.

We claim:

1. A method of determining the regularity of a surface of an object under examination, the method comprising:
a) receiving a three-dimensional phase image of the surface based on a multiple wavelength interferometric analysis of the surface, wherein the phase image of the surface includes a plurality of pixels;
b) determining a relative height of the pixels in response to the phase image of the surface;
c) creating a statistical map of the surface in response to the relative height of the pixels; and
d) determining the regularity of the surface of the object under examination in response to the statistical map of the surface.

2. The method of claim 1, wherein step (a) further includes, for each of the pixels and for each of the wavelengths in the interferometric analysis, extracting a peak value of a Fourier transform resulting in a phase value for each of the pixels.

3. The method of claim 1, wherein step (a) further includes, for each of the pixels and for each of the wavelengths in the interferometric analysis, extracting one or more of the parameters selected from the group consisting of object reflectivity, Depth of modulation, and response to illumination wavelength.

4. The method of claim 1, wherein step (d) further includes comparing the statistical map of the surface of the object under examination to a statistical map of a comparable surface of a comparable object.

5. The method of claim 4, wherein the statistical map of the comparable surface is provided by performing steps (a), (b), and (c) on the comparable surface.

6. The method of claim 4, wherein the statistical map of the comparable surface includes an idealized statistical map of the comparable surface.

7. The method of claim 1, wherein step (d) further includes identifying one or more marks on the surface of the object under examination in response to the statistical map of the surface of the object.

8. The method of claim 7, further comprising adjusting an interferometric system in response to a regular mark identified on the surface of the object under examination.

9. The method of claim 7, further comprising:
e) segmenting the three-dimensional phase image in response to one or more irregular marks identified on the surface of the object under examination.

10. The method of claim 9, further comprising:
f) adjusting an analysis of one or more of the pixels in response to the segment in which each of the pixels is disposed.

11. The method of claim 10, wherein step (g) further includes performing a step from the group consisting of: adjusting the density of a set of reference pixels usable in determining the relative height of the pixels, adjusting the exposure time of the interferometric system for one or more segments, and adjusting a focal parameter of the interferometric system for one or more segments.

12. The method of claim 1, wherein step (d) further includes identifying a defect on the surface of the object under examination in response to the three-dimensional phase image of the surface.

13. The method of claim 12, wherein the step of identifying a defect on the surface of the object under examination includes identifying a defective pixel within the pixels.

14. The method of claim 13, further comprising the step of clustering the defective pixels in order to determine a parameter of the defect on the surface selected from the group consisting of size, shape, volume, and location.

15. A system for examining a surface comprising:
an interferometric apparatus adapted to generate a three-dimensional phase image of a surface of an object under examination; and
a controller connected to the interferometric apparatus, the controller adapted to determine a relative height of each of the pixels in response to the phase image of the surface; create a statistical map of the surface in response to the relative height of each of the pixels; and determine the regularity of the surface of the object under examination in response to the statistical map of the surface.

16. The system of claim 15, wherein the interferometric apparatus is adapted to generate an interferogram of the surface using more than two wavelengths of light.

17. The system of claim 15, wherein the controller is further adapted to compare the statistical map of the surface of the object under examination to a statistical map of a comparable surface of a comparable object.

18. The system of claim 17, wherein the statistical map of the comparable surface includes stored data of a previous analysis of the comparable surface.

19. The system of claim 17, wherein the statistical map of the comparable surface includes an idealized statistical map of the comparable surface.

20. The system of claim 15, wherein the controller is further adapted to adjust the operation of the interferometric apparatus in response to the identification of a mark on the surface of the object under examination.
